(19) United States
(12) Patent Application Publication
(10) Pub. No.: US 2026/0303360 A1
(43) Pub. Date: Oct. 1, 2026

(54) SYSTEMS AND METHODS FOR AGENT-CONTROLLED APPLICATION WORKSPACES WITH DECISION PROOF OBJECT-GOVERNED APPLICATION ACTION BROKERAGE

(71) Applicant: Jacob Crowley, Largo, FL (US)

(72) Inventor: Jacob Crowley, Largo, FL (US)

(73) Assignee: MyAKH Inc, Clearwater, FL (US)

(21) Appl. No.: 19/693,546

(22) Filed: May 31, 2026

Related U.S. Application Data
(63) Continuation-in-part of application No. 19/567,956, filed on Mar. 16, 2026.
(63) Continuation-in-part of application No. 19/333,759, filed on Sep. 19, 2025, now Pat. No. 12,700,162.

(51) Int. Cl. H04L 9/32; G06N 3/006

(52) U.S. Cl. CPC H04L 9/3247; G06N 3/006; H04L 9/3221

(57) ABSTRACT

An agent-controlled application workspace governs artificial intelligence control of enrolled applications. A user interface presents an application control container that receives an enrollment action for an application representation. An application enrollment component creates an application control record comprising authorized action classes, a permitted usage scope, and an application capability manifest hash generated from a bounded action surface of the enrolled application. An agent orchestration component receives an agent control request and translates the request into a requested application action. A governance evaluation component generates or obtains a Decision Proof Object comprising a canonical identity context, an application control record reference, the application capability manifest hash, a consent state reference, a decision outcome, and a cryptographic signature. An application action broker refuses invocation of the requested application action unless the Decision Proof Object validates and the decision outcome indicates authorization.

### CROSS-REFERENCE TO RELATED APPLICATIONS

The present application is a continuation-in-part of U.S. patent application Ser. No. 19/567,956, filed Mar. 16, 2026, titled “Systems and Methods for Digital Identity Governance, Authorized AI Representation, and Autonomous Agent Execution,” which is a continuation-in-part of U.S. patent application Ser. No. 19/333,759, filed Sep. 19, 2025, titled “Systems and Methods for Creating Interactive AI Human Avatars from Multimodal Data for Legacy Preservation, Training, and Entertainment.” The entire disclosures of the foregoing applications are incorporated herein by reference in their entirety.

### TECHNICAL FIELD

The present disclosure relates to artificial intelligence control of software applications, application automation, digital identity governance, agentic execution, application action brokerage, digital twins, cryptographically verifiable authorization, Decision Proof Object-governed runtime execution, and fail-closed control of application actions performed by artificial intelligence agents.

### BACKGROUND

Artificial intelligence agents increasingly receive natural-language and programmatic requests to perform actions using software applications, cloud services, mobile applications, desktop applications, enterprise workflows, browser-based services, external application programming interfaces, and operating-system action interfaces. Existing application launchers, app folders, shortcut systems, intent frameworks, robotic process automation systems, workflow engines, and agent-action frameworks can expose application functionality to a user or an artificial intelligence assistant. However, these systems generally do not cryptographically bind a user identity, application action surface, consent state, and requested action into a fail-closed execution authorization artifact before the application action is invoked.

A technical risk arises when an artificial intelligence agent has access to multiple applications and is prompted to perform actions on behalf of a user. Prompt injection, confused-deputy behavior, ambiguous identity context, overbroad credentials, malicious automation, unauthorized account interactions, unexpected application version changes, and action-surface drift can cause unauthorized data mutations, external calls, account changes, file modifications, financial transactions, or generation of unauthorized digital outputs.

There is a need for an agent-controlled application workspace in which applications are enrolled into a governed execution container and an artificial intelligence agent can invoke only those application actions that are authorized by application control records and validated by a cryptographically verifiable Decision Proof Object. There is also a need for a fail-closed application action broker that prevents the agent from directly invoking enrolled applications outside a bounded action interface.

### SUMMARY

In some embodiments, an agent-controlled application workspace governs artificial intelligence control of enrolled applications. A user interface presents an application control container, which may be displayed as a folder-like or briefcase-like workspace. An enrollment action, including a drag-and-drop enrollment action, causes an application enrollment component to create an application control record for an enrolled application. The application control record stores an application identifier, authorized action classes, permitted usage scope, credential vault reference, revocation or expiration conditions, and an application capability manifest hash.

The application capability manifest hash is generated by executing a cryptographic hash function over an application capability manifest defining a bounded action surface of the enrolled application. The bounded action surface may include callable functions, data access permissions, operating-system intents, application programming interface operations, browser-extension operations, enterprise workflow actions, native extension operations, or robotic process automation actions.

An agent orchestration component receives a user instruction and proposes a requested application action. A governance evaluation component operates in conjunction with an Identity Resolution Service to resolve identity inputs into a canonical identity context under a fail-closed ambiguity constraint. The governance evaluation component evaluates the requested application action against the application control record, authorized action classes, permitted usage scope, identity context, consent state, and manifest hash.

A Decision Proof Object is generated or obtained for the requested application action. The Decision Proof Object binds the canonical identity context to the application capability manifest hash and the decision outcome. To ensure deterministic execution, an application action broker refuses invocation of the requested application action unless the Decision Proof Object validates and the decision outcome indicates authorization for the requested application action.

### BRIEF DESCRIPTION OF THE DRAWINGS

FIG. 1 illustrates an agent-controlled application workspace overview.

FIG. 2 illustrates an application enrollment interface with a folder-like or briefcase-like application control container.

FIG. 3 illustrates an application control record and application capability manifest structure.

FIG. 4 illustrates an agent action request and Decision Proof Object validation flow.

FIG. 5 illustrates application action broker refusal and credential vault isolation.

FIG. 6 illustrates audit and replay architecture for enrolled application actions.

FIG. 7 illustrates a hardware-isolated secure execution environment embodiment for local execution.

FIG. 8 illustrates a zero-knowledge Decision Proof Object gateway embodiment.

FIG. 9 illustrates capability manifest parsing and bounded action mapping.

FIG. 10 illustrates cryptographic provenance metadata and automated takedown or revocation flow.

FIG. 11 illustrates biometric digital twin feature mapping and VERSION_MISMATCH handling.

### DETAILED DESCRIPTION

### Computing System Infrastructure and Execution Environment

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

The disclosed embodiments reside primarily in combinations of components related to computing devices, secure hardware execution environments, and cryptographic network systems. The computer system that may be utilized to execute various procedures, including the agent-controlled application workspace processes described herein, comprises a standalone computer or mobile computing device, a mainframe computer system, a workstation, a network computer, a desktop computer, a laptop, or the like. The computing device can be embedded in another device, e.g., a mobile telephone, an augmented reality (AR) or virtual reality (VR) headset, a vehicle computing system, a personal digital assistant (PDA), a game console, an edge-computing gateway, or a portable storage device.

The computer system includes one or more processors coupled to a memory through a system bus that couples various system components, such as input/output (I/O) devices, to the processors. The bus may be any of several types of bus structures including a memory bus or memory controller, a peripheral bus, and a local bus using any of a variety of bus architectures. For example, such architecture includes Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

The computer system includes one or more input/output (I/O) devices, such as video device(s) (e.g., a camera, volumetric scanner, or depth sensor), audio device(s) (e.g., a microphone array), and display(s) in operable communication with the computer system. In some embodiments, similar I/O devices may be separate from the computer system and may interact with one or more nodes of the computer system through a wired or wireless connection, such as over a network interface.

Processors suitable for the execution of computer readable program instructions include both general and special purpose microprocessors and any one or more processors of any digital computing device. For example, each processor may be a single processing unit or a number of processing units and may include single or multiple computing units or multiple processing cores. The processor(s) can be implemented as one or more microprocessors, microcomputers, microcontrollers, digital signal processors (DSP), central processing units (CPU), neural processing units (NPU), tensor processing units (TPU), graphics processing units (GPU), state machines, logic circuitries, and/or any devices that manipulate signals based on operational instructions. For example, the processor(s) may be one or more hardware processors and/or logic circuits of any suitable type specifically programmed or configured to execute the cryptographic, identity canonicalization, and agent orchestration algorithms described herein.

The processor(s) can be configured to fetch and execute computer readable program instructions stored in the computer-readable media, which can program the processor(s) to perform the functions described herein. The term “processor” can refer to substantially any computing processing unit or device, including an application specific integrated circuit (ASIC), a field programmable gate array (FPGA), a programmable logic controller (PLC), a complex programmable logic device (CPLD), discrete gate or transistor logic, discrete hardware components, or any combination thereof designed to perform the functions described herein.

The memory includes computer-readable application instructions, configured to implement certain embodiments described herein, and a database or credential vault, comprising various data accessible by the application instructions. The application instructions include software elements corresponding to one or more of the various embodiments described herein. The terms “store,” “storage,” “data store,” “data storage,” “database,” and “credential vault” refer to memory components, which are entities embodied in a memory. The memory and/or memory components described herein can be volatile memory, nonvolatile memory, or both. Nonvolatile memory can include read only memory (ROM), programmable ROM (PROM), electrically programmable ROM (EPROM), electrically erasable ROM (EEPROM), flash memory, or nonvolatile random-access memory (RAM). Volatile memory can include RAM, which can function as external cache memory.

A computing device will also include or be operatively coupled to receive data from or transfer data to one or more mass data storage devices. Hosting platforms may be implemented including public or private clouds. Further, various cloud storage systems including table storage, blob storage databases, distributed ledgers, blockchain nodes, and peer-to-peer storage networks may be used. The computer readable storage medium can be a tangible device that can retain and store instructions for use by an instruction execution device. In this disclosure, a computer readable storage medium is not to be construed as being transitory signals per se, such as radio waves or other freely propagating electromagnetic waves.

The steps and actions of the application instructions described herein are embodied directly in hardware, in a software module executed by a processor, or in a combination of the two. In some embodiments, the application instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages. The application instructions can execute entirely on the user's computer, partly on the user's computer, as a stand-alone software package, partly on the user's computer and partly on a remote computer, or entirely on the remote computer or server.

In some embodiments, the system can also be implemented in cloud computing environments. In this context, “cloud computing” refers to a model for enabling ubiquitous, convenient, on-demand network access to a shared pool of configurable computing resources that can be rapidly provisioned via virtualization and released with minimal management effort or service provider interaction. A cloud model can be composed of various characteristics, service models (e.g., Software as a Service (“SaaS”), Platform as a Service (“PaaS”), Infrastructure as a Service (“IaaS”)), and deployment models (e.g., private cloud, community cloud, public cloud, hybrid cloud).

### Detailed Description of the Drawings and Reference Numerals

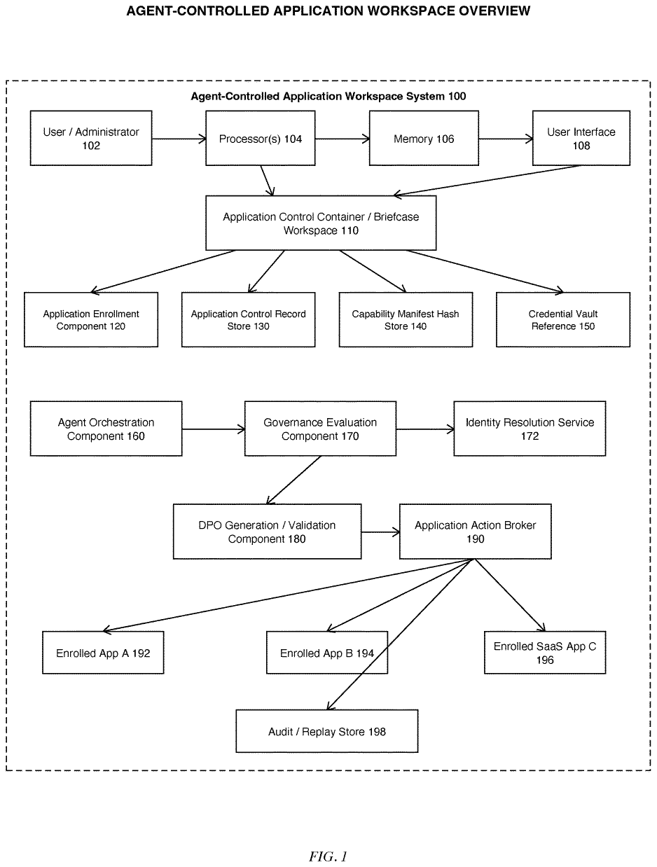

FIG. 1 illustrates an agent-controlled application workspace system 100. A user or administrator 102 interacts with processor(s) 104, memory 106, and a user interface 108. The user interface 108 presents an application control container or Briefcase workspace 110. An application enrollment component 120 creates or updates records in an application control record store 130 and may populate a capability manifest hash store 140 and credential vault reference 150. An agent orchestration component 160 communicates with a governance evaluation component 170 and an Identity Resolution Service 172. A Decision Proof Object generation/verification component 180 cooperates with an application action broker 190, which controls enrolled applications such as enrolled app A 192, enrolled app B 194, and enrolled SaaS app C 196. Audit and replay store 198 records decisions and execution outcomes.

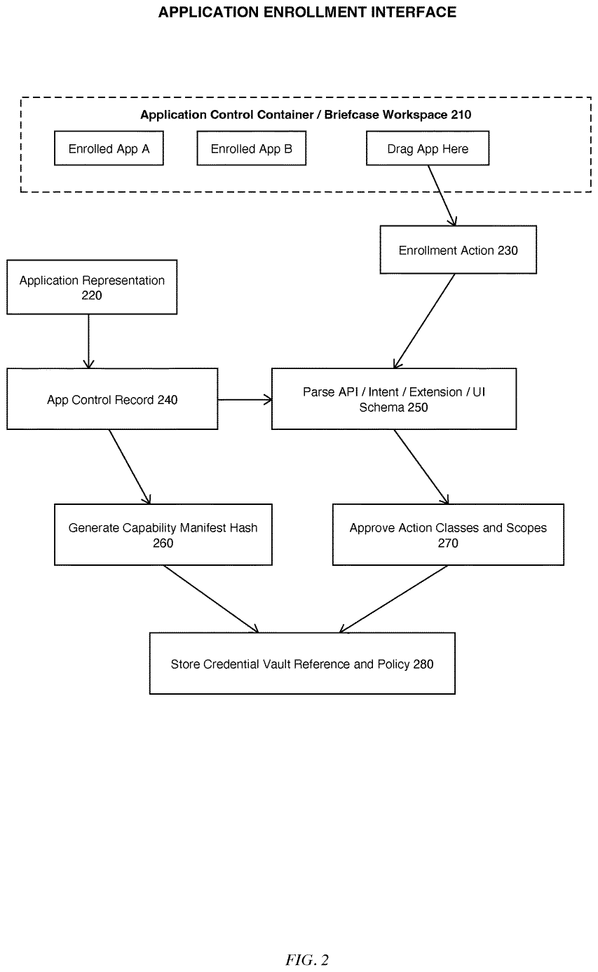

FIG. 2 illustrates an application enrollment interface. An application control container or Briefcase workspace 210 receives application representations. In the example shown, an application representation 220 is enrolled through an enrollment action 230. The enrollment action 230 causes creation of an application control record 240, parsing of an application programming interface, intent, extension, or user-interface schema 250, generation of a capability manifest hash 260, approval of action classes and scopes 270, and storage of a credential vault reference and policy 280.

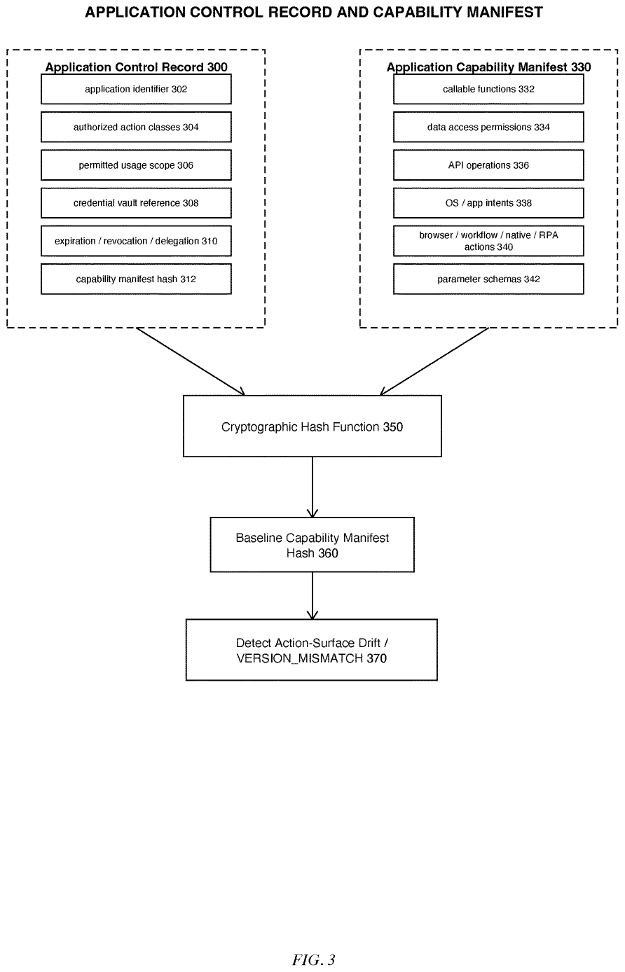

FIG. 3 illustrates an application control record 300 and an application capability manifest 330. The application control record 300 may include an application identifier 302, authorized action classes 304, permitted usage scope 306, credential vault reference 308, expiration, revocation, or delegation data 310, and capability manifest hash 312. The application capability manifest 330 may include callable functions 332, data access permissions 334, application programming interface operations 336, operating-system or app intents 338, browser, workflow, native, or robotic-process-automation actions 340, and parameter schemas 342. A cryptographic hash function 350 generates a baseline capability manifest hash 360, which can be used to detect action-surface drift or trigger a VERSION_MISMATCH state 370.

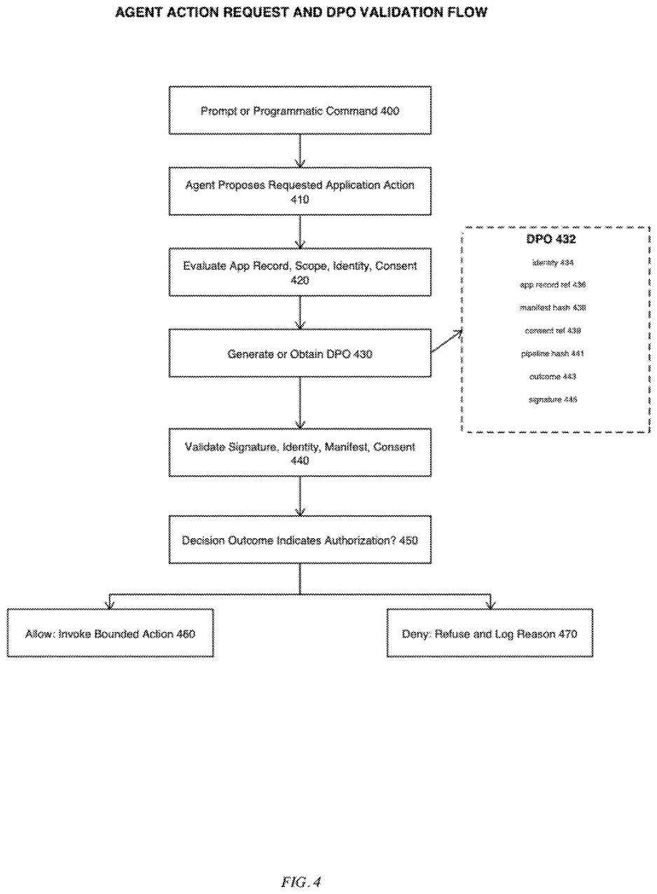

FIG. 4 illustrates an agent action request and Decision Proof Object validation flow. A prompt or programmatic command is received at step 400. An agent proposes a requested application action at step 410. The system evaluates an application record, scope, identity, and consent at step 420, and generates or obtains a Decision Proof Object at step 430. The Decision Proof Object 432 may include canonical identity context 434, application control record reference 436, application capability manifest hash 438, consent state reference or block-height snapshot 439, pipeline manifest hash 441, decision outcome 443, and cryptographic signature 445. Validation of signature, identity, manifest, and consent occurs at step 440. A determination of whether the decision outcome indicates authorization occurs at step 450. If authorized, the broker invokes a bounded action at step 460; otherwise, the broker refuses and logs a reason at step 470.

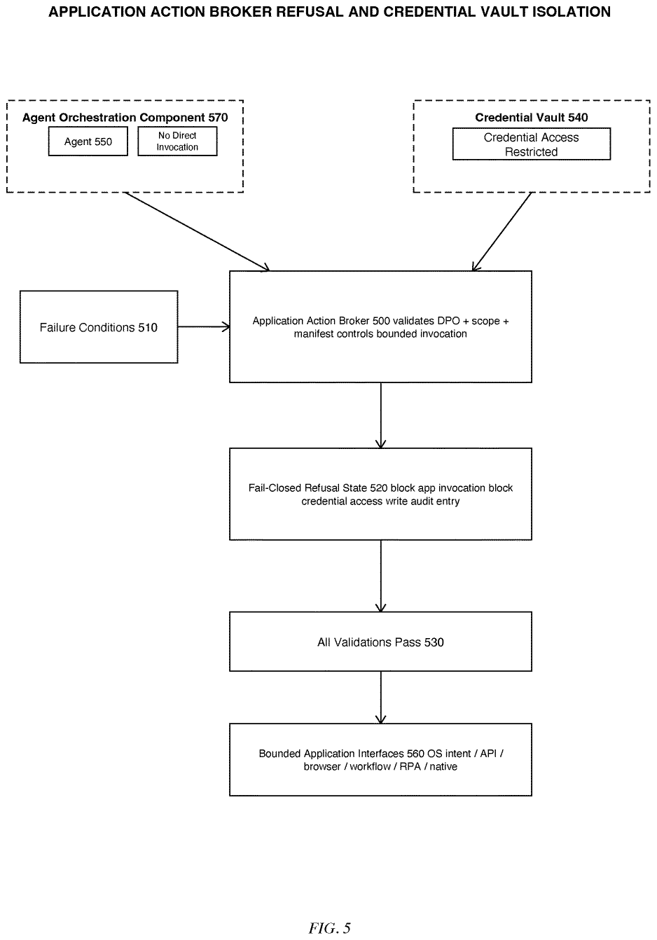

FIG. 5 illustrates application action broker refusal and credential vault isolation. Agent orchestration component 570 does not directly invoke enrolled applications or access credential vault 540. Application action broker 500 validates a Decision Proof Object, enforces action scope, and controls bounded invocation. Failure conditions 510 include absence of a Decision Proof Object, signature failure, manifest hash mismatch, unauthorized action class, invalid consent state, prompt injection, or anomaly detection. A fail-closed refusal state 520 blocks application invocation, blocks credential access, writes an audit entry, and returns a refusal reason. Only after all validations pass 530 can the broker invoke bounded application interfaces 560, such as operating-system intent, application programming interface, browser, enterprise, robotic-process-automation, or native interfaces. No raw credentials are exposed to the agent 550.

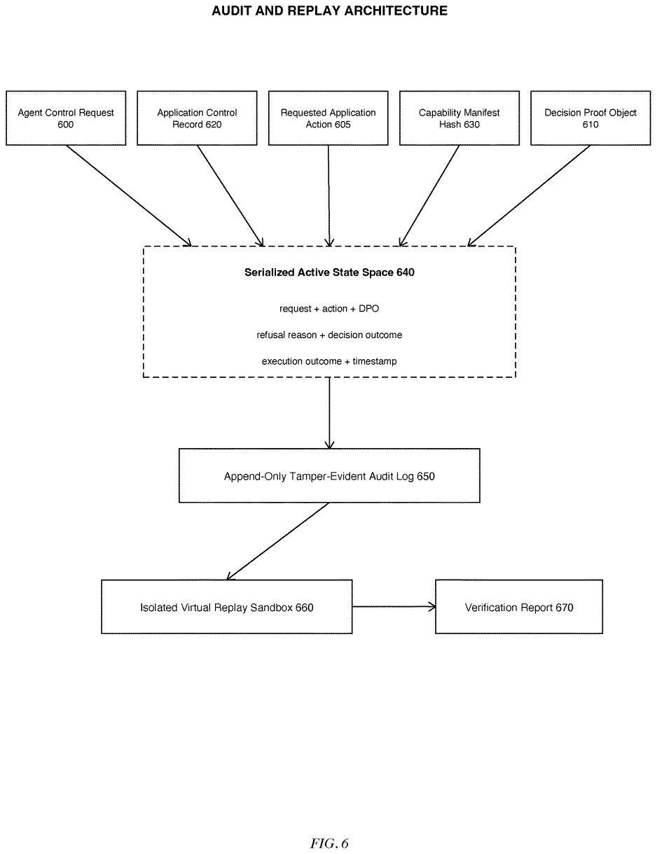

FIG. 6 illustrates audit and replay architecture. An agent control request 600, requested application action 605, Decision Proof Object 610, application control record 620, and capability manifest hash 630 may be serialized into active state space 640. The serialized active state space 640 may include the request, action, Decision Proof Object, refusal reason, decision outcome, execution outcome, and timestamp. The serialized active state space 640 is committed to an append-only tamper-evident audit log 650. An isolated virtual replay sandbox 660 may reconstruct authorization state and produce a verification report 670.

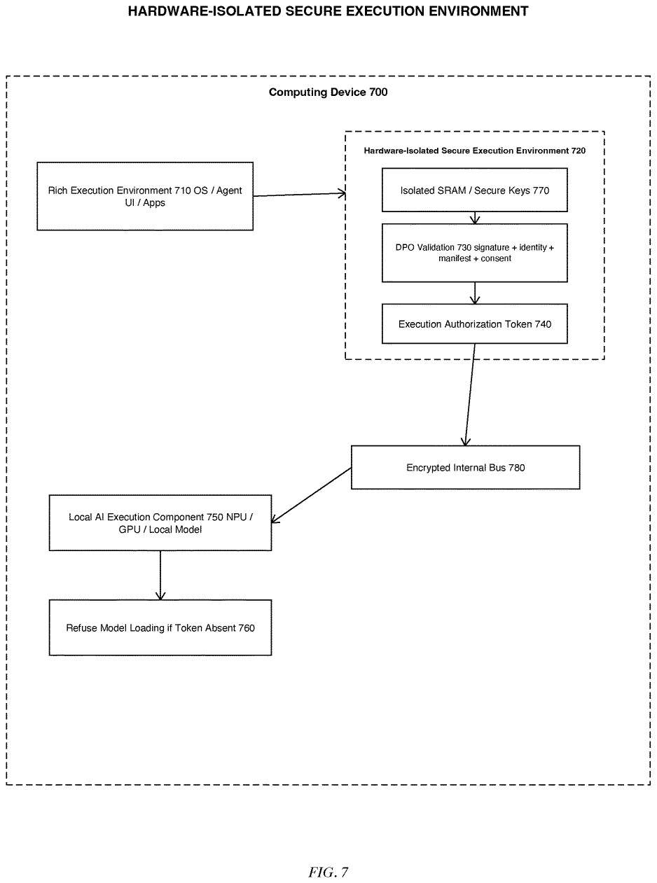

FIG. 7 illustrates a hardware-isolated secure execution environment embodiment. A computing device 700 includes a rich execution environment 710 and a hardware-isolated secure execution environment 720. The hardware-isolated secure execution environment 720 may contain isolated static random-access memory or secure keys 770 and may perform Decision Proof Object validation 730. Upon successful validation, an execution authorization artifact 740 may pass across an encrypted internal bus 780 to a local artificial intelligence execution component 750. Model loading may be refused when the execution authorization artifact is absent 760.

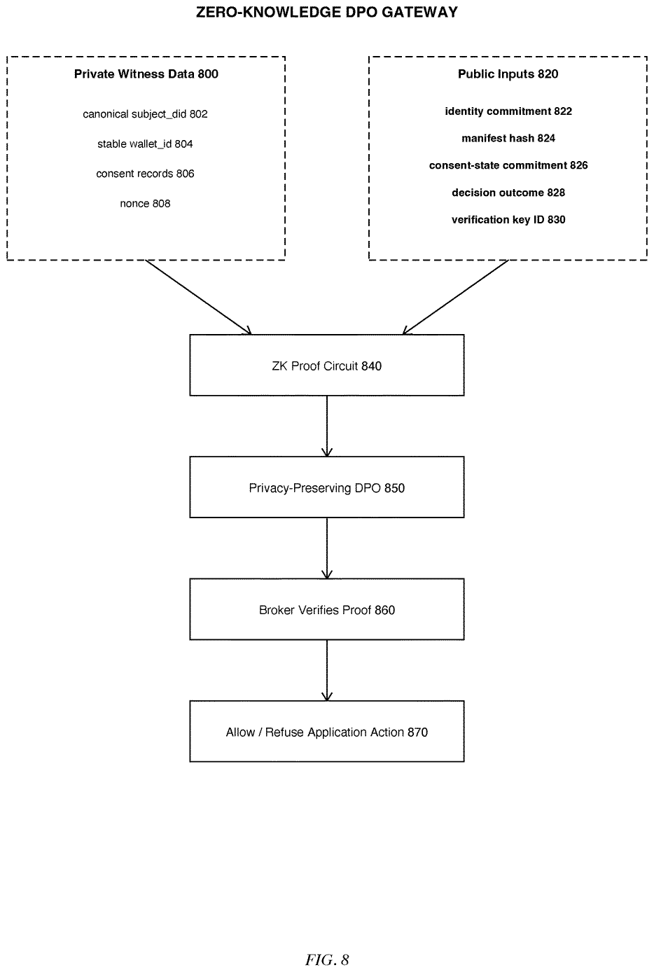

FIG. 8 illustrates a zero-knowledge Decision Proof Object gateway. Private witness data 800 may include canonical subject_did 802, stable wallet_id 804, consent records 806, and nonce 808. Public inputs 820 may include identity commitment 822, manifest hash 824, consent-state commitment 826, decision outcome 828, and verification key identifier 830. A zero-knowledge proof circuit 840 generates a privacy-preserving Decision Proof Object 850. The broker verifies the zero-knowledge proof 860 and allows or refuses an application action 870.

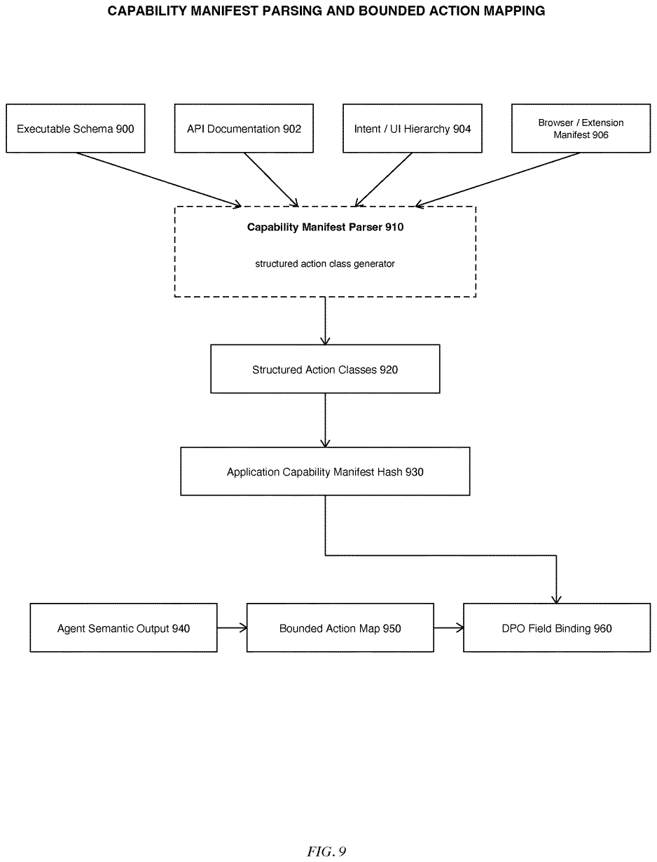

FIG. 9 illustrates capability manifest parsing and bounded action mapping. Executable schema 900, application programming interface documentation 902, intent or user-interface hierarchy 904, and browser or extension manifest 906 may be parsed by a capability manifest parser 910. The parser 910 generates structured action classes 920 and an application capability manifest hash 930. Agent semantic output 940 is mapped into a bounded action map 950, which may be used for Decision Proof Object field binding 960.

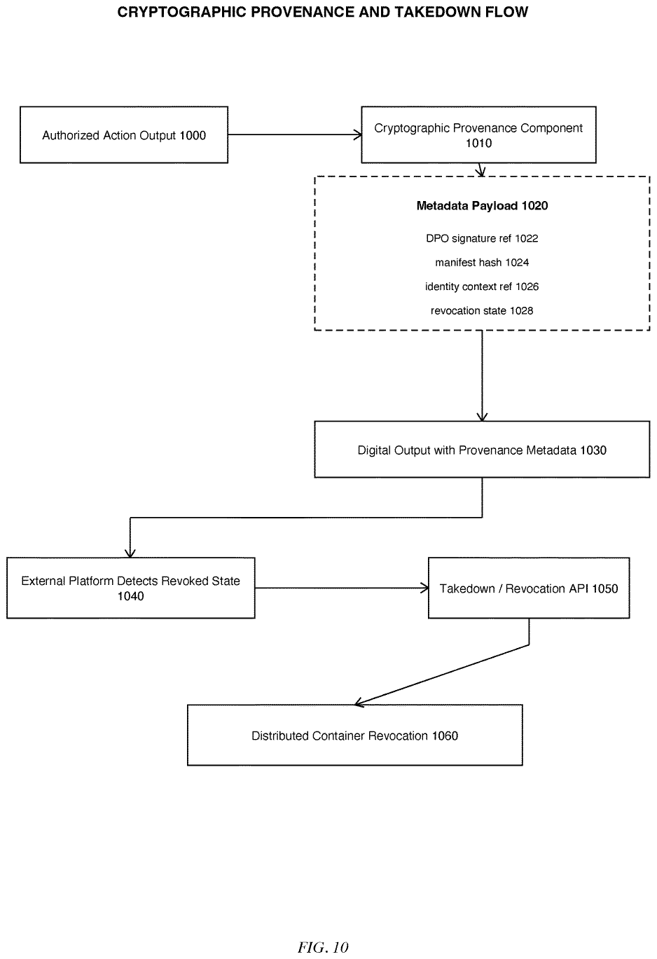

FIG. 10 illustrates cryptographic provenance and takedown flow. An authorized action output 1000 is processed by a cryptographic provenance component 1010. A metadata payload 1020 may include Decision Proof Object signature reference 1022, manifest hash 1024, identity context reference 1026, and revocation state 1028. A digital output with provenance metadata 1030 can be inspected by an external platform that detects a revoked state 1040. A takedown or revocation application programming interface 1050 may trigger distributed container revocation 1060.

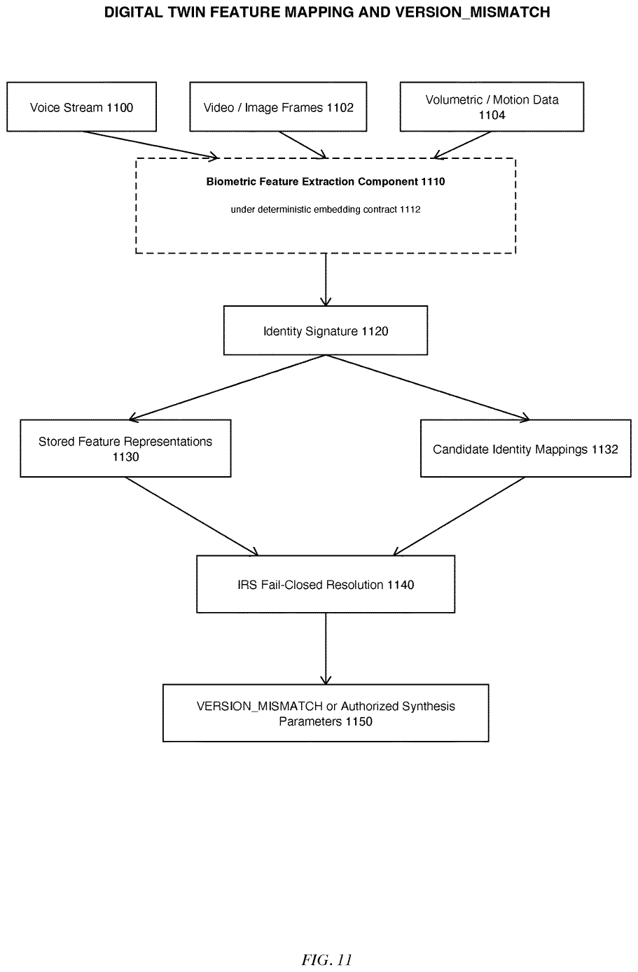

FIG. 11 illustrates digital twin feature mapping and VERSION_MISMATCH handling. A voice stream 1100, video or image frames 1102, and volumetric or motion data 1104 may be processed by a biometric feature extraction component 1110 under a deterministic embedding contract 1112 to generate an identity signature 1120. Stored feature representations 1130 and candidate identity mappings 1132 are evaluated by IRS fail-closed resolution 1140. The system returns VERSION_MISMATCH or authorized synthesis parameters 1150 depending on compatibility and authorization.

### Definitions

Application control container: a graphical, programmatic, or administrative workspace configured to hold one or more application representations that have been enrolled for governed artificial intelligence control. In some embodiments, the application control container is displayed as a folder-like or briefcase-like workspace, referred to as a Briefcase workspace, that visually groups applications under a common agentic governance policy.

Application representation: an application icon, shortcut, browser extension target, software-as-a-service connector, mobile application reference, desktop application reference, enterprise application reference, workflow connector, native extension reference, or equivalent reference to a controllable application or service.

Application control record: a machine-readable record created for an enrolled application. The record may include an application identifier, authorized action classes, permitted usage scope, expiration condition, revocation condition, delegation constraint, identity requirement, consent requirement, credential vault reference, application capability manifest hash, and audit configuration.

Application capability manifest: a structured description of actions exposed for possible invocation by an application. The manifest may describe callable functions, data-access permissions, external application programming interface operations, workflow actions, operating-system intents, app-intent actions, browser-extension operations, screen-automation permissions, native extension operations, user-interface operations, or enterprise workflow actions.

Application capability manifest hash: a cryptographic hash of an application capability manifest. The hash enables detection of application version drift, manifest substitution, action-surface expansion, unauthorized app modification, or capability mismatch.

Agent orchestration component: a processor-implemented component configured to receive natural-language or programmatic instructions and propose application actions. The agent orchestration component does not directly invoke enrolled applications outside the application action broker.

Application action broker: a processor-implemented enforcement component configured to invoke enrolled application actions only after validation of an execution authorization artifact, specifically a Decision Proof Object (DPO). The broker may interact with applications through operating-system intent interfaces, application programming interface connectors, browser extensions, robotic process automation connectors, enterprise workflow connectors, native application extensions, or local automation permission interfaces.

Bounded action surface: the set of application actions, parameters, data permissions, external calls, account interactions, and workflow operations that an enrolled application is permitted to expose for agentic invocation under the application control record.

Credential vault reference: a pointer, handle, token reference, or secure enclave reference used by the application action broker to obtain an access artifact without exposing raw credentials to an agent orchestration component.

Decision Proof Object: a cryptographically verifiable execution authorization object comprising fields that can include canonical identity context, a reference to an application control record, an application capability manifest hash, a consent state reference, a pipeline manifest hash, a decision outcome, and a cryptographic signature.

Execution authorization artifact: a cryptographically verifiable token, explicitly referenced herein as a Decision Proof Object (DPO), which binds the identity resolution, consent state evaluation, and execution environment validation into a unified gating artifact.

Fail-closed ambiguity constraint: an identity-resolution rule under which downstream execution is terminated when multiple candidate identity mappings satisfy identity resolution criteria or when canonical identity context cannot be established with sufficient determinism.

### Agent-Controlled Application Workspace System Overview

The present disclosure describes a computer-implemented agent-controlled application workspace system configured to technically, logically, and cryptographically govern orchestration of enrolled applications by artificial intelligence agents. The system mitigates confused-deputy vulnerabilities, prompt-injection attacks, unauthorized application actions, and action-surface drift by enforcing a cryptographic fail-closed execution loop before invocation of any third-party application programming interface, operating-system intent, browser extension action, enterprise workflow connector, robotic process automation action, local automation permission, or native application extension.

Referring to FIG. 1, an agent-controlled application workspace system 100 executes on a computing device comprising one or more processors 104 and non-transitory computer-readable memory 106. A user or administrator 102 interacts with the system via a user interface 108. The memory 106 stores executable instructions that instantiate an application control container 110. The application control container 110 may function as a secure administrative workspace, a folder-like interface, a Briefcase workspace, a governed app container, or a policy-controlled app tray that groups enrolled applications under a common agentic governance policy.

An application enrollment component 120 receives an enrollment action via the user interface 108. The application enrollment component 120 instantiates an application control record in an application control record store 130, binding an application identifier to an application capability manifest hash stored in a capability manifest hash store 140, a permitted usage scope, authorized action classes, revocation or expiration conditions, and a credential vault reference 150.

An agent orchestration component 160 may comprise a transformer-based large language model, specialized reasoning engine, rule-based planner, workflow engine, or hybrid orchestration engine. The agent orchestration component 160 receives natural-language or programmatic user requests and translates those requests into proposed application actions. The agent orchestration component 160 is isolated from direct invocation of enrolled applications and lacks direct access to raw secrets stored in the credential vault reference 150.

Before execution, a governance evaluation component 170 evaluates the proposed application action. The governance evaluation component 170 operates in conjunction with an Identity Resolution Service 172 configured to execute a fail-closed ambiguity constraint. The Identity Resolution Service 172 resolves incoming user or session signals into a canonical identity context comprising a canonical subject_did and a stable wallet_id. A Decision Proof Object generation/verification component 180 generates or obtains a Decision Proof Object for the proposed application action.

The final execution phase is governed by an application action broker 190. The application action broker 190 may operate as a reverse proxy, system-level interceptor, workflow connector, application programming interface gateway, browser extension mediator, operating-system action interface, native extension interface, robotic process automation gate, or local automation permission gate. Only upon successful validation of the Decision Proof Object does the application action broker 190 execute a bounded action, pass a bounded payload to an enrolled application 192, 194, 196, and record the outcome in an audit and replay store 198.

Federated Multi-Tenant Cryptographic Partitioning. In enterprise embodiments, the agent-controlled application workspace can operate as a multi-tenant governance architecture serving multiple corporate entities, organizational divisions, business units, regulated departments, or customer workspaces. To prevent cross-tenant data contamination and unauthorized lateral invocation, the system may enforce federated cryptographic partitioning.

Application control records may be partitioned using tenant-specific logical stores, database shards, cryptographic namespaces, or policy partitions. Each application control record can be bound to a tenant identifier. The Identity Resolution Service 172 can restrict candidate identity mappings to a tenant-specific identity domain before resolving a canonical identity context. When a Decision Proof Object is generated or verified, the cryptographic signature can be associated with tenant-specific key material or a tenant-specific verification profile. The application action broker 190 refuses execution when a Decision Proof Object generated for one tenant is presented for invocation of an application enrolled under another tenant.

Application Enrollment and Capability Manifest Hash Generation. Referring to FIG. 2, the user interface 108 may present an application control container 210 containing application representations and a target zone for enrollment. An enrollment action 230, such as dragging an application representation 220 into the application control container 210, triggers creation of an application control record 240.

During enrollment, the system performs parsing step 250. The application enrollment component 120 may parse executable schemas, application programming interface routing structures, OpenAPI documents, GraphQL schemas, operating-system intent declarations, browser extension manifests, native extension declarations, enterprise workflow definitions, automation descriptors, or user-interface hierarchies. The parsed information is converted into an application capability manifest defining the bounded action surface of the enrolled application.

The system executes step 260 by generating a capability manifest hash using a collision-resistant cryptographic hash function such as SHA-2, SHA-3, BLAKE3, or another cryptographic digest algorithm. The administrator, rights holder, tenant administrator, or authorized user may approve action classes and scopes at step 270. The system stores credential vault references and policy controls at step 280.

Referring to FIG. 3, an application control record 300 may store an application identifier 302, authorized action classes 304, permitted usage scope 306, credential vault reference 308, expiration, revocation, or delegation data 310, and capability manifest hash 312. A corresponding application capability manifest 330 may define callable functions 332, data access permissions 334, application programming interface operations 336, operating-system or app intents 338, browser/workflow/native/RPA actions 340, and parameter schemas 342. A cryptographic hash function 350 processes the manifest 330 to produce a baseline capability manifest hash 360. During execution, a current application capability manifest hash can be compared to the baseline capability manifest hash 360 to detect action-surface drift and trigger VERSION_MISMATCH state 370 when the enrolled application has materially changed without re-enrollment or reauthorization.

Cryptographic Quota Depletion and Bounded Execution Loops. In some embodiments, the permitted usage scope 306 governs computational resource consumption and prevents runaway agentic execution loops. Artificial intelligence agents may encounter application errors, recursive prompts, or repeated external-call instructions that would otherwise cause high-frequency invocation of application programming interfaces or excessive resource consumption.

The permitted usage scope 306 may include a quota-depletion matrix defining an upper bound for application programming interface invocations, transaction count, total payload size, model tokens, execution time, data mutation count, or workflow operations within a defined window. A Decision Proof Object may include or reference a monotonic nonce or quota state associated with the application control record 300. The application action broker 190 updates the quota state after invocation and refuses further invocation when the quota state is depleted. This refusal occurs at the application action broker 190 and does not require the agent orchestration component 160 to self-police recursive behavior.

Agent Request Evaluation and Decision Proof Object Generation. Referring to FIG. 4, a prompt or programmatic command is received at step 400. The agent orchestration component 160 proposes a requested application action at step 410. The governance evaluation component 170 evaluates application record, scope, identity, and consent at step 420. A Decision Proof Object is generated or obtained at step 430.

The Decision Proof Object 432 may comprise canonical identity context 434, application control record reference 436, application capability manifest hash 438, consent state reference or block-height snapshot 439, pipeline manifest hash 441, decision outcome 443, and cryptographic signature 445. The canonical identity context 434 may include a canonical subject_did and a stable wallet_id generated by the Identity Resolution Service 172 under a fail-closed ambiguity constraint. The pipeline manifest hash 441 may identify a model execution pipeline, reasoning model, preprocessing configuration, prompt template configuration, or tool-selection configuration used by the agent orchestration component 160.

Validation occurs at step 440. The application action broker 190 or governance evaluation component 170 verifies the cryptographic signature 445, canonical identity context 434, application control record reference 436, application capability manifest hash 438, consent state reference 439, and decision outcome 443. A determination of whether the decision outcome indicates authorization occurs at step 450. If authorization is confirmed, the broker invokes a bounded action at step 460. If authorization is absent, expired, mismatched, revoked, ambiguous, or incompatible, the broker refuses execution and logs a refusal reason at step 470.

Application Action Broker and Credential Vault Isolation. Referring to FIG. 5, the agent orchestration component 570 does not directly invoke enrolled applications or access the credential vault 540. The application action broker 500 validates a Decision Proof Object, enforces permitted usage scope, and controls bounded invocation of enrolled applications. Failure conditions 510 may include absence of a Decision Proof Object, cryptographic signature failure, application capability manifest hash mismatch, unauthorized action class, invalid consent state, prompt injection detection, anomaly detection, exhausted quota state, expired credential vault reference, tenant mismatch, or ambiguous identity context.

A fail-closed refusal state 520 blocks application invocation, blocks credential access, writes an audit entry, and returns a refusal reason. Only after all validations pass 530 can the broker invoke bounded application interfaces 560, such as operating-system intent, application programming interface, browser, enterprise workflow, robotic process automation, local automation permission, or native extension interfaces. Raw credentials, secrets, refresh tokens, private keys, and session tokens are not exposed to the agent orchestration component 550. Instead, the application action broker 500 may use a credential vault reference to request a scoped access artifact or session handle and pass only a bounded execution payload to the enrolled application.

Hardware-Isolated Secure Execution Environment Embodiment. Referring to FIG. 7, a high-assurance embodiment can execute at least part of the governance evaluation component 170, Decision Proof Object generation/verification component 180, or application action broker 190 within a hardware-isolated secure execution environment 720. A computing device 700 includes a rich execution environment 710 and the hardware-isolated secure execution environment 720. The hardware-isolated secure execution environment 720 may comprise a secure enclave, trusted execution environment, hardware security module, secure element, processor enclave, confidential-compute environment, or dedicated secure co-processor.

The hardware-isolated secure execution environment 720 may maintain isolated memory and secure keys 770 separated from the rich execution environment 710 and an untrusted operating system kernel. A Decision Proof Object may be routed into the hardware-isolated secure execution environment 720 through a secure mailbox, trusted path, encrypted memory region, or attested call interface. The secure environment may perform Decision Proof Object validation 730 by validating a cryptographic signature, canonical identity context, application capability manifest hash, consent state reference, and decision outcome.

Upon successful validation, the hardware-isolated secure execution environment 720 may transmit an execution authorization artifact 740 across an encrypted internal bus 780 to a local artificial intelligence execution component 750. Model loading, instruction queue processing, local action invocation, or local workflow execution may be refused when the execution authorization artifact is absent 760. The hardware-isolated secure execution environment 720 may erase temporary verification state after approval or denial of a requested application action.

Decentralized Ledger and Consent Registry Embodiment. In distributed topology embodiments, authorization records, permitted usage scopes, application control records, application capability manifest hashes, revocation states, or delegation constraints may be anchored to a distributed ledger, blockchain network, smart contract registry, hash-linked log, or other tamper-evident consent registry. A consent state reference embedded within a Decision Proof Object may comprise a block-height snapshot reference including a block number, associated block hash, consent policy hash, registry identifier, or revocation state marker.

The governance evaluation component 170 may verify consent state at the referenced block-height snapshot and refuse execution when a revocation, expiration, delegation change, ledger mismatch, or consent policy mismatch is detected. This embodiment can support delegated workflows in which an artificial intelligence agent or designated representative requests to act on behalf of a user, wallet, account, application container, enterprise identity, or digital twin. The system remains distinct from account-code delegation because the application action broker 190 requires an application control record, application capability manifest hash, canonical identity context, consent state reference, and Decision Proof Object validation before application action invocation.

Zero-Knowledge Privacy-Preserving Gateway Embodiment. Referring to FIG. 8, privacy-preserving embodiments may use zero-knowledge authorization. Private witness data 800 may include canonical subject_did 802, stable wallet_id 804, consent records 806, and nonce 808. Public inputs 820 may include identity commitment 822, manifest hash 824, consent-state commitment 826, decision outcome 828, and verification key identifier 830. A zero-knowledge proof circuit 840 generates a privacy-preserving Decision Proof Object 850.

The Identity Resolution Service 172 resolves incoming signals into a canonical identity context. A commitment generation component may hash, salt, blind, or otherwise commit to the canonical identity context to produce an unlinkable identity commitment 822. A proof generation component may execute a non-interactive zero-knowledge proof circuit using private witness data 800. Public inputs 820 may be provided to a broker verification process 860. The application action broker 190 may validate the zero-knowledge proof against the public inputs 820 and allow or refuse an application action 870 without receiving underlying identity inputs or consent records in plaintext.

Capability Manifest Parsing and Bounded Action Mapping. Referring to FIG. 9, the application enrollment component 120 may implement a parser 910 configured to ingest structured or unstructured application descriptions. Executable schema 900, application programming interface documentation 902, intent or user-interface hierarchy 904, and browser or extension manifest 906 may be processed by the parser 910. The parser 910 generates structured action classes 920 and an application capability manifest hash 930.

Agent semantic output 940 may be mapped into a bounded action map 950 before Decision Proof Object field binding 960. If the semantic output cannot be mapped to a structured action class 920, if required parameters exceed the permitted usage scope 306, if the application capability manifest hash 930 no longer matches the baseline hash 360, or if the requested action is outside the authorized action classes 304, the governance evaluation component 170 refuses authorization. This structure prevents semantic execution drift by requiring the requested application action to map to an explicit manifest-defined action class before invocation.

Digital Twin and Biometric Feature Mapping Embodiment. Referring to FIG. 11, digital twin and interactive artificial intelligence (AI) avatar embodiments may process real-time multimodal inputs, including a voice stream 1100, video or image frames 1102, and volumetric or motion data 1104. A biometric feature extraction component 1110 processes the inputs under a deterministic embedding contract 1112 to generate an identity signature 1120. Stored feature representations 1130 and candidate identity mappings 1132 are evaluated by IRS fail-closed resolution 1140.

The deterministic embedding contract 1112 may define a model identifier, preprocessing configuration identifier, configuration hash, feature-generation parameters, or declared execution configuration. If model parameters, preprocessing configuration, stored feature representations, or feature-generation conditions are incompatible, the system returns VERSION_MISMATCH or authorized synthesis parameters 1150 depending on compatibility and authorization. The application action broker 190 can refuse passage of synthesis parameters, voice-generation parameters, facial animation parameters, avatar rendering parameters, or digital twin control parameters unless the identity signature 1120 and candidate identity mappings 1132 validate under the Identity Resolution Service 172.

Cryptographic Provenance Metadata and Takedown Embodiment. Referring to FIG. 10, in embodiments that generate media or digital outputs, an authorized action output 1000 may be processed by a cryptographic provenance component 1010. A metadata payload 1020 may include a Decision Proof Object signature reference 1022, manifest hash 1024, identity context reference 1026, and revocation state 1028. The metadata payload 1020 may be inserted into, associated with, or cryptographically bound to a digital output with provenance metadata 1030.

The provenance metadata can be compatible with content provenance standards, cryptographic watermarking formats, content credentials, manifest structures, or custom provenance records. The system is not limited to a particular provenance standard. An external platform may inspect the digital output with provenance metadata 1030 and detect a revoked state 1040. A takedown or revocation application programming interface 1050 may then trigger distributed container revocation 1060, which propagates a revoked state to application control containers, governance registries, or brokers associated with the same canonical identity context, application control record, or output authorization.

Audit, Replay, Anomaly Detection, and Forensic Isolation. Referring to FIG. 6, an agent control request 600, requested application action 605, Decision Proof Object 610, application control record 620, and capability manifest hash 630 may be serialized into active state space 640. The serialized active state space 640 can include the request, action, Decision Proof Object, refusal reason, decision outcome, execution outcome, timestamp, application control record reference, manifest hash, agent prompt context, and execution state. The serialized active state space 640 is committed to an append-only tamper-evident audit log 650. An isolated virtual replay sandbox 660 may reconstruct authorization state and produce a verification report 670.

The application action broker 190 and governance evaluation component 170 may monitor for failure conditions including cryptographic signature mismatch, out-of-sync consent state reference, application capability manifest hash discrepancy, requested action outside an authorized action class, invalid canonical identity context, expired credential vault reference, anomalous prompt-injection score, model execution configuration mismatch, quota depletion, tenant mismatch, or zero-knowledge proof verification failure.

Upon detecting a failure condition, the application action broker 190 suspends the proposed application action, blocks access to credentials, refuses network or application invocation, and records a refusal reason. In some embodiments, the broker serializes an active state space and commits it to an append-only tamper-evident audit log for replay within an isolated virtual sandbox 660. The replay operation reconstructs the authorization decision without exposing production credentials or executing the refused action.

Delegated, Posthumous, and Fiduciary Control Embodiments. In some embodiments, the agent-controlled application workspace supports application orchestration on behalf of another individual, account, enterprise, estate, or digital twin. The application control record 300 may include delegation data 310 defining a designated representative, authorized administrator, fiduciary, successor, executor, guardian, or enterprise delegate permitted to approve or modify selected governance rules. The delegation data 310 can define the scope of actions, revocation conditions, expiration conditions, required approvals, and identity requirements for the representative.

In posthumous or digital estate embodiments, an identity inheritance structure may identify one or more successors authorized to modify governance rules associated with a real individual or digital twin. The system may require multi-signature approval, verifiable credential presentation, or cryptographic endorsement before a representative can modify permitted usage scope 306, authorized action classes 304, or an application control record 300. Pending policy modifications may remain in an unexecuted state until a required approval threshold is satisfied. If the threshold is not satisfied within a defined window, the system can purge the pending policy modification object from memory 106 and return a security failure state.

Behavioral authenticity constraints may restrict the agent orchestration component 160 from proposing application actions that fall outside stored feature representations, memory graphs, trait vectors, linguistic patterns, sentiment boundaries, or decision-making parameters associated with a digital twin. When a proposed application action deviates beyond a predefined authenticity threshold, the application action broker 190 can suspend the action, request additional authorization, record a refusal reason, or require a representative override before generating or validating a Decision Proof Object.

Block-Height Snapshot Consent Enforcement. In blockchain-integrated or tamper-evident registry embodiments, the system retrieves the consent state governing the application workspace at a specific block-height snapshot. The system may record a block number, associated block hash, consent policy hash, registry identifier, or revocation state marker to freeze the policy state at evaluation time. This snapshot information may be included as part of the consent state reference embedded within the Decision Proof Object 432.

An enforcement decision is valid only if the consent policy hash, application control record reference, and application capability manifest hash match the state evaluated at the captured snapshot. This deterministic anchoring helps prevent race conditions arising from revocation updates, policy changes, manifest substitutions, or application control record modifications transmitted between decision generation and execution.

System Advantages and Technical Improvements. The disclosed architecture provides technical improvements to computer security, application automation, agentic execution, and digital identity governance. By cryptographically binding an application capability manifest hash to canonical identity context, consent state, and a requested application action within a Decision Proof Object, the system restricts an artificial intelligence agent to a bounded action surface defined at enrollment time.

The architecture can prevent prompt-injected agents from invoking unauthorized applications, limit access to functions expressly defined in the application capability manifest, isolate raw credential material from the agent orchestration component, enforce per-action authorization through the application action broker, detect action-surface drift through application capability manifest hashes, and generate replayable audit evidence without exposing production systems to repeated execution of refused actions.

The disclosed embodiments are not limited to any particular operating system, application marketplace, artificial intelligence model, cloud provider, hardware enclave, blockchain network, credential provider, provenance standard, or zero-knowledge proof protocol. Equivalent implementations may substitute other cryptographic primitives, identity proofing methods, secure execution mechanisms, application connector types, audit-log structures, or user-interface configurations while preserving the fail-closed DPO-governed application action brokerage architecture described herein.

Scope of Disclosure and Equivalents. The descriptions of the various embodiments have been presented for purposes of illustration and are not intended to be exhaustive or limited to the exact embodiments disclosed. Many modifications and variations will be apparent to those of ordinary skill in the art without departing from the scope and spirit of the described embodiments. The terminology used herein was chosen to explain the principles of the embodiments, the practical application, and the technical improvements over conventional application launchers, action-intent frameworks, robotic process automation systems, and agent-action frameworks.

The operations and components described herein represent multiple operational contexts of the same underlying technological improvement: a governance architecture that evaluates identity-bound authorization conditions before permitting downstream agentic orchestration of enrolled applications. The hardware-isolated secure execution environment, zero-knowledge authorization gateway, digital twin feature mapping, multi-signature delegation, provenance metadata, and audit replay embodiments may operate as alternative or complementary technical execution controls implemented by the same overarching governance evaluation and application action brokerage architecture.

What is claimed is:

1. A computer-implemented agent-controlled application workspace system for cryptographically governing artificial intelligence control of enrolled applications, the system comprising:
one or more processors; and
memory storing instructions that, when executed by the one or more processors, cause the system to implement:
a user interface implemented by the one or more processors and configured to present an application control container that receives an enrollment action for an application representation associated with an application;
an application enrollment component implemented by the one or more processors and configured to create an application control record for the application in response to the enrollment action, the application control record comprising an application identifier, one or more authorized action classes, a permitted usage scope, and an application capability manifest hash generated by executing a cryptographic hash function over an application capability manifest defining a bounded action surface of the application;
an agent orchestration component implemented by the one or more processors and configured to receive an agent control request and translate the agent control request into a requested application action associated with the application;
a governance evaluation component implemented by the one or more processors and configured to evaluate the requested application action against the application control record, the one or more authorized action classes, and the permitted usage scope;
a Decision Proof Object generation component implemented by the one or more processors and configured to generate or obtain a Decision Proof Object for the requested application action, the Decision Proof Object comprising a canonical identity context, a reference to the application control record, the application capability manifest hash, a consent state reference, a decision outcome, and a cryptographic signature, wherein the canonical identity context comprises a canonical subject_did and a stable wallet_id generated by an Identity Resolution Service operating under a fail-closed ambiguity constraint; and
an application action broker implemented by the one or more processors and configured to refuse invocation of the requested application action through an operating-system intent interface, application programming interface, browser extension interface, enterprise workflow connector, robotic process automation connector, or native application extension unless the cryptographic signature, the canonical identity context, the reference to the application control record, the application capability manifest hash, and the consent state reference are successfully validated, and the decision outcome indicates authorization for the requested application action.

2. The system of claim 1, wherein the application control container is displayed as a folder-like or briefcase-like workspace and the enrollment action comprises dragging the application representation into the application control container.

3. The system of claim 1, wherein the application representation comprises an application icon, application shortcut, browser extension target, software-as-a-service connector, mobile application reference, desktop application reference, enterprise application reference, workflow connector, or application programming interface connector.

4. The system of claim 1, wherein the application capability manifest defines callable functions, data-access permissions, external application programming interface operations, screen-automation permissions, operating-system intents, app-intent actions, browser-extension operations, enterprise workflow actions, or native application extension operations exposed by the application.

5. The system of claim 1, wherein the application action broker is configured to access the application through at least one of an operating-system intent interface, application programming interface connector, browser extension, robotic process automation connector, enterprise workflow connector, native application extension, or local automation permission interface.

6. The system of claim 1, wherein a credential vault is accessible only through the application action broker, and wherein the agent orchestration component is configured without direct access to the credential vault or to an invocation interface for the application outside the application action broker.

7. The system of claim 1, wherein the application action broker is configured to refuse invocation of the requested application action when the requested application action is not included in the one or more authorized action classes.

8. The system of claim 1, wherein the application action broker is configured to refuse invocation of the requested application action when the application capability manifest hash does not match a declared application capability manifest for the application.

9. The system of claim 1, wherein the application control record further comprises a credential vault reference, a revocation condition, an expiration condition, a delegation constraint, an identity requirement, or a consent requirement.

10. The system of claim 1, wherein the Decision Proof Object further comprises a pipeline manifest hash identifying a model execution pipeline used by the agent orchestration component to generate the requested application action.

11. The system of claim 1, wherein the consent state reference corresponds to a consent registry state represented by a block-height snapshot reference comprising a block number and an associated block hash.

12. The system of claim 1, wherein at least one of the governance evaluation component or the application action broker is executed within a hardware-isolated secure execution environment, and wherein the hardware-isolated secure execution environment is configured to transmit an execution authorization token to a local artificial intelligence execution component only after successful validation of the Decision Proof Object.

13. The system of claim 1, wherein the Decision Proof Object comprises a zero-knowledge proof generated using private witness data comprising underlying identity inputs and consent-state information associated with the canonical identity context, and wherein the application action broker validates the zero-knowledge proof against public inputs comprising an identity commitment and the application capability manifest hash without receiving the underlying identity inputs or underlying consent records in plaintext.

14. The system of claim 1, wherein the application enrollment component comprises a parser configured to ingest an executable schema, application programming interface documentation, operating-system intent declaration, app-intent declaration, browser extension manifest, enterprise workflow definition, or user-interface hierarchy and convert the ingested information into structured action classes included in the application capability manifest.

15. The system of claim 1, further comprising a biometric feature extraction component implemented by the one or more processors and configured to process voice, image, video, or volumetric sensor data into an identity signature under a deterministic embedding contract, and wherein the system returns a VERSION_MISMATCH state when model parameters used to generate the identity signature are incompatible with stored feature representations associated with the canonical identity context.

16. The system of claim 1, further comprising a cryptographic provenance component implemented by the one or more processors and configured to inject a cryptographic provenance metadata payload into a digital output generated by the requested application action, the cryptographic provenance metadata payload comprising a representation of at least one of the cryptographic signature, the application capability manifest hash, or a reference to the canonical identity context.

17. The system of claim 1, wherein, upon detecting a manifest hash discrepancy between a hash of a current application capability manifest and the application capability manifest hash in the application control record, the application action broker is configured to suspend an active execution thread, block access to a credential vault, serialize an active state space comprising the requested application action and the Decision Proof Object, and commit the serialized active state space to an append-only tamper-evident audit log for replay within an isolated virtual sandbox.

18. A computer-implemented method for cryptographically governing artificial intelligence control of enrolled applications, the method comprising:
presenting, by one or more processors, an application control container configured to receive an enrollment action for an application representation associated with an application;
creating, by an application enrollment component implemented by the one or more processors, an application control record for the application in response to the enrollment action, the application control record comprising an application identifier, one or more authorized action classes, a permitted usage scope, and an application capability manifest hash generated by executing a cryptographic hash function over an application capability manifest defining a bounded action surface of the application;
receiving, by an agent orchestration component implemented by the one or more processors, an agent control request and translating the agent control request into a requested application action associated with the application;
evaluating, by a governance evaluation component implemented by the one or more processors, the requested application action against the application control record, the one or more authorized action classes, and the permitted usage scope;
generating or obtaining, by the one or more processors, a Decision Proof Object for the requested application action, the Decision Proof Object comprising a canonical identity context, a reference to the application control record, the application capability manifest hash, a consent state reference, a decision outcome, and a cryptographic signature, wherein the canonical identity context comprises a canonical subject_did and a stable wallet_id generated by an Identity Resolution Service operating under a fail-closed ambiguity constraint; and
refusing, by an application action broker implemented by the one or more processors, invocation of the requested application action unless the cryptographic signature, the canonical identity context, the reference to the application control record, the application capability manifest hash, and the consent state reference are successfully validated, and the decision outcome indicates authorization for the requested application action.

19. The method of claim 18, further comprising recording an audit-log entry comprising the agent control request, the requested application action, the application control record, the application capability manifest hash, the decision outcome, a refusal reason, and an execution outcome.

20. A non-transitory computer-readable storage medium storing instructions that, when executed by one or more processors, cause the one or more processors to perform operations comprising:
presenting an application control container configured to receive an enrollment action for an application representation associated with an application;
creating an application control record for the application in response to the enrollment action, the application control record comprising an application identifier, one or more authorized action classes, a permitted usage scope, and an application capability manifest hash generated by executing a cryptographic hash function over an application capability manifest defining a bounded action surface of the application;
receiving an agent control request and translating the agent control request into a requested application action associated with the application;
generating or obtaining a Decision Proof Object for the requested application action, the Decision Proof Object comprising a canonical identity context, a reference to the application control record, the application capability manifest hash, a consent state reference, a decision outcome, and a cryptographic signature, wherein the canonical identity context comprises a canonical subject_did and a stable wallet_id generated by an Identity Resolution Service operating under a fail-closed ambiguity constraint; and
refusing invocation of the requested application action unless the cryptographic signature, the canonical identity context, the reference to the application control record, the application capability manifest hash, and the consent state reference are successfully validated, and the decision outcome indicates authorization for the requested application action.
